(19) United States
(12) Patent Application Publication
(10) Pub. No.: US 2022/0316310 A1
(43) Pub. Date: Oct. 6, 2022

(54) REDUCING UNCERTAINTY IN A PREDICTED BASIN MODEL

(71) Applicant: Halliburton Energy Services, Inc., Houston, TX (US)

(72) Inventors: Elham Mohsenian, Houston, TX (US); Claudia Lucia Bonin De Oliveira, Katy, TX (US); Dale E. Jamison, Humble, TX (US)

(21) Appl. No.: 17/219,022

(22) Filed: Mar. 31, 2021

(51) Int. Cl. E21B 44/00; E21B 43/25; E21B 10/62

(52) U.S. Cl. CPC E21B 44/00; E21B 43/25; E21B 10/62

(57) ABSTRACT

The disclosure presents processes for updating a prediction for the basin model and compaction model for a borehole. The results of the predicted parameters can be utilized by a drilling controller to adjust a drilling process, such as rotational speed, drilling fluid composition, drilling fluid additives, and other drilling process parameters. The predictions can be updated at various time intervals, such as real-time or near real-time for data collected by downhole sensors and a different time interval for sensor data collected at a lag time, such as cuttings analyzed by surface sensors. Throughout a drilling stage, the drilling process can be updated as new sensor data is received, allowing the uncertainty of the predictions to be reduced as new data is incorporated into the basin and compaction models, thereby enabling an increase in efficiency and optimization of the drilling process.

### TECHNICAL FIELD

This application is directed, in general, to estimating characteristics of a subterranean formation and, more specifically, to predicting a basin model.

### BACKGROUND

When developing and drilling boreholes, it is important to be able to predict the characteristics of the composition and compaction of the surrounding subterranean formation. Understanding of the characteristics can enable better optimization of the drilling fluids used, as well as improve the efficiency of the drilling process. In many scenarios, the subterranean formation characteristics ahead of the drilling operation is not known. Being able to reduce the uncertainty of the subterranean formation characteristics around and ahead of the drilling operation can lead to more efficient operations of the drilling operation thereby being able to reduce costs.

### SUMMARY

In one aspect, a method is disclosed. In one embodiment, the method includes (1) receiving input parameters for a prediction model of an active borehole for a drilling stage, wherein the prediction model utilizes a basin model and a compaction model, (2) generating predicted characteristics of a subterranean formation of the active borehole utilizing the prediction model and the input parameters, and (3) reducing an estimation uncertainty of the predicted characteristics of the subterranean formation by analyzing a geo-mechanical model with the basin model, and updating the basin model using sensor data collected from sensors located downhole or proximate the active borehole, and the sensor data is collected in a real-time, a near real-time, or at a lag time.

In a second aspect, a prediction modeler system is disclosed. In one embodiment, the prediction modeler system includes (1) a parameter receiver, capable to receive input parameters relating to an active borehole and a subterranean formation in which the active borehole is located, and (2) a prediction generator, capable of utilizing the input parameters to determine result parameters including one or more basin models, one or more compaction models, one or more fracture gradients, or one or more elastic moduli, wherein the input parameters are modified during a drilling stage using first sensor data collected in real-time, near real-time, and at a lag time.

In a third aspect, a computer program product having a series of operating instructions stored on a non-transitory computer-readable medium that directs a data processing apparatus when executed thereby to perform operations is disclosed. In one embodiment, the operations include (1) receiving input parameters for a prediction model of an active borehole for a drilling stage, wherein the prediction model utilizes a basin model and a compaction model, (2) generating predicted characteristics of a subterranean formation of the active borehole utilizing the prediction model and the input parameters, and (3) reducing an estimation uncertainty of the predicted characteristics of the subterranean formation by analyzing a geo-mechanical model with the basin model, and updating the basin model using sensor data collected from sensors located downhole or proximate the active borehole, and the sensor data is collected in a real-time, a near real-time, or at a lag time.

### BRIEF DESCRIPTION

Reference is now made to the following descriptions taken in conjunction with the accompanying drawings, in which:

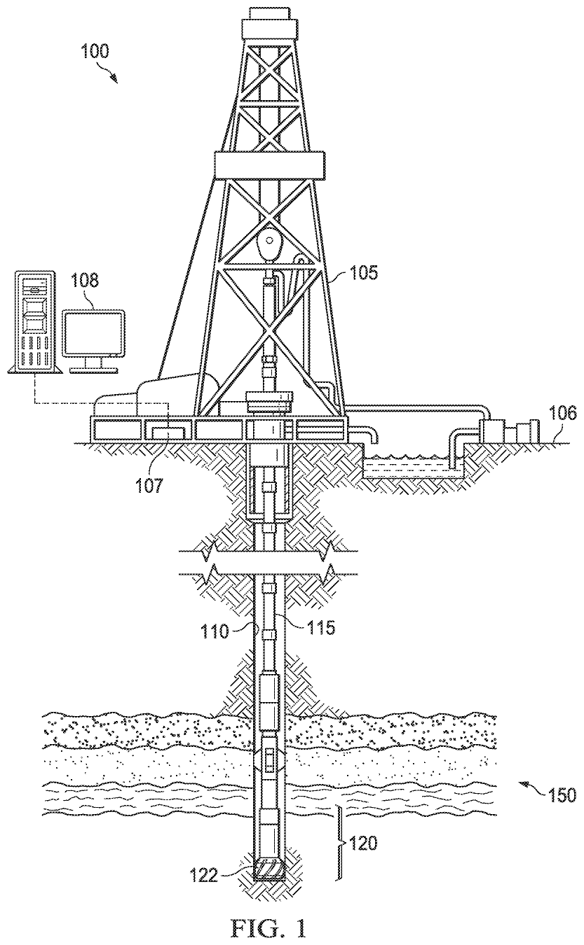

FIG. 1 is an illustration of a diagram of an example drilling system;

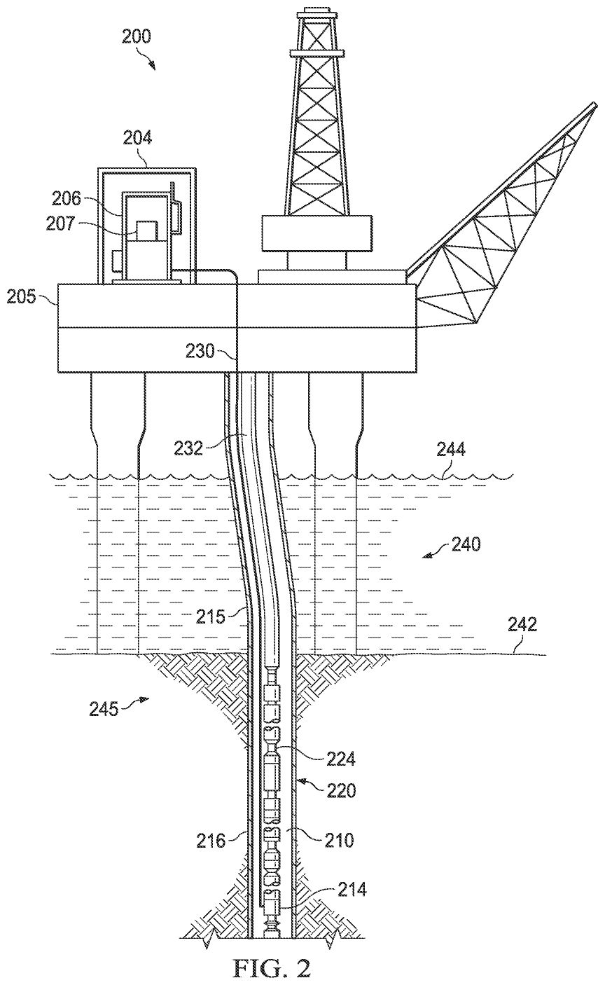

FIG. 2 is an illustration of a diagram of an example offshore system;

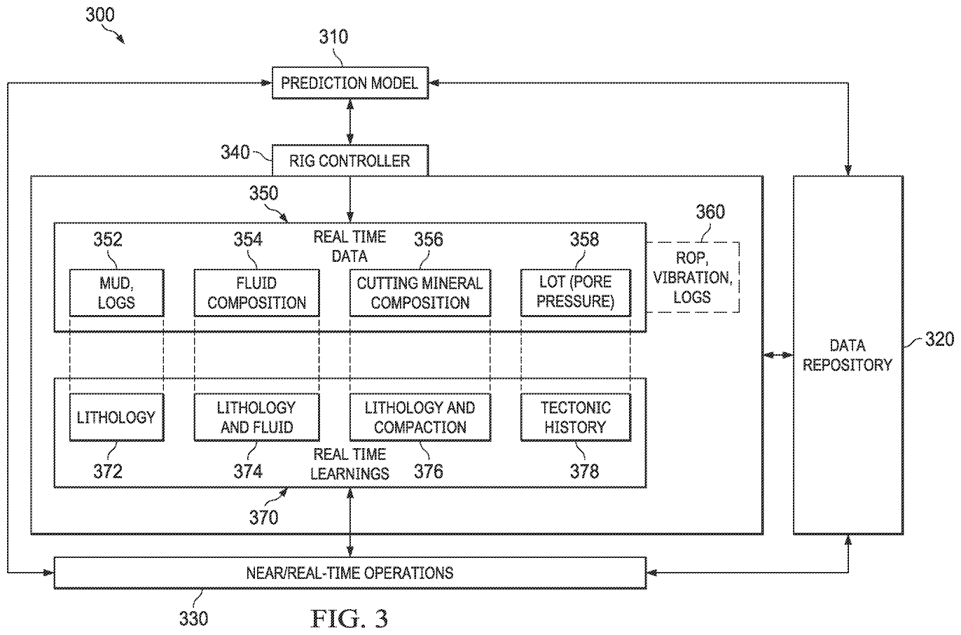

FIG. 3 is an illustration of a block diagram of an example drilling prediction flow;

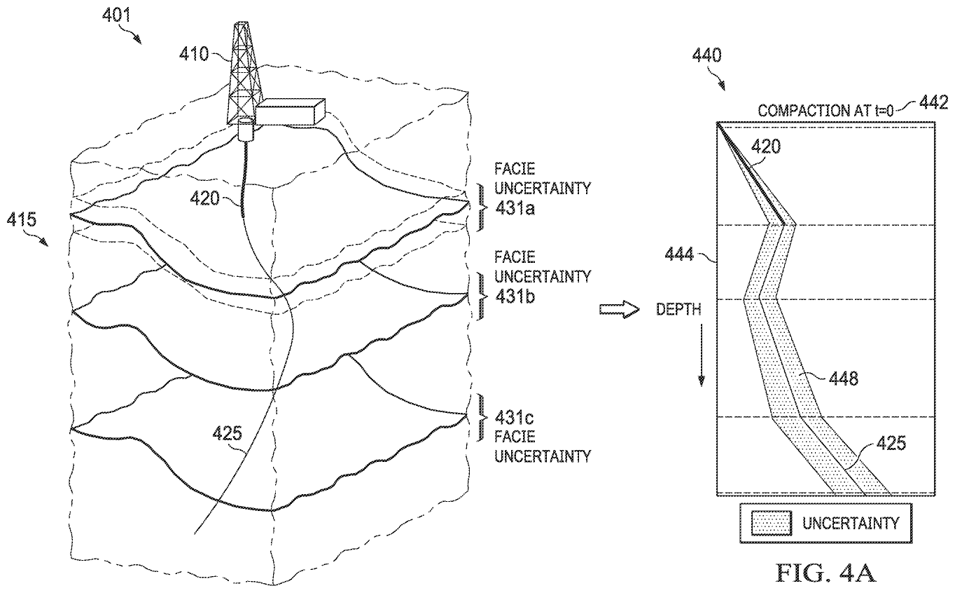

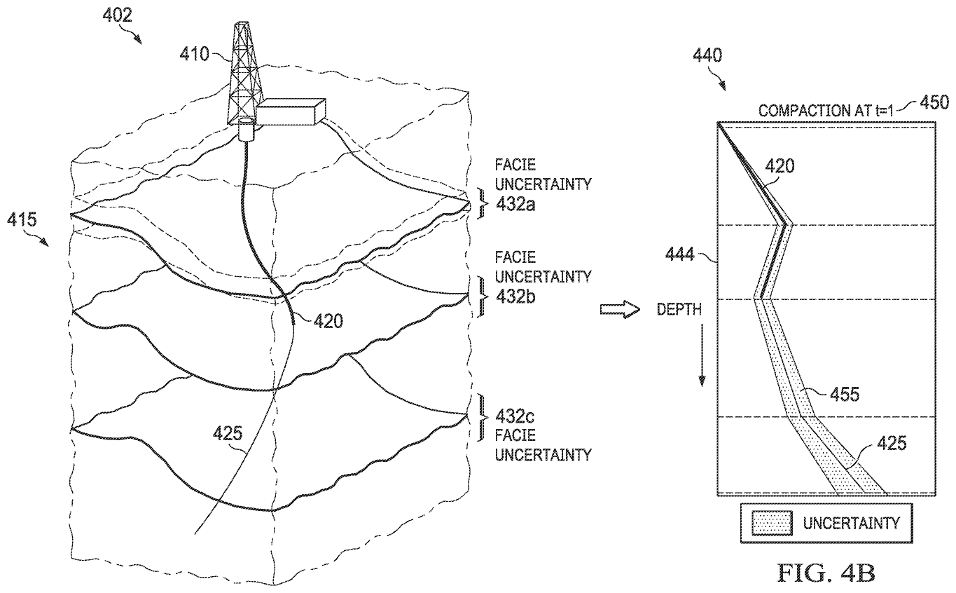

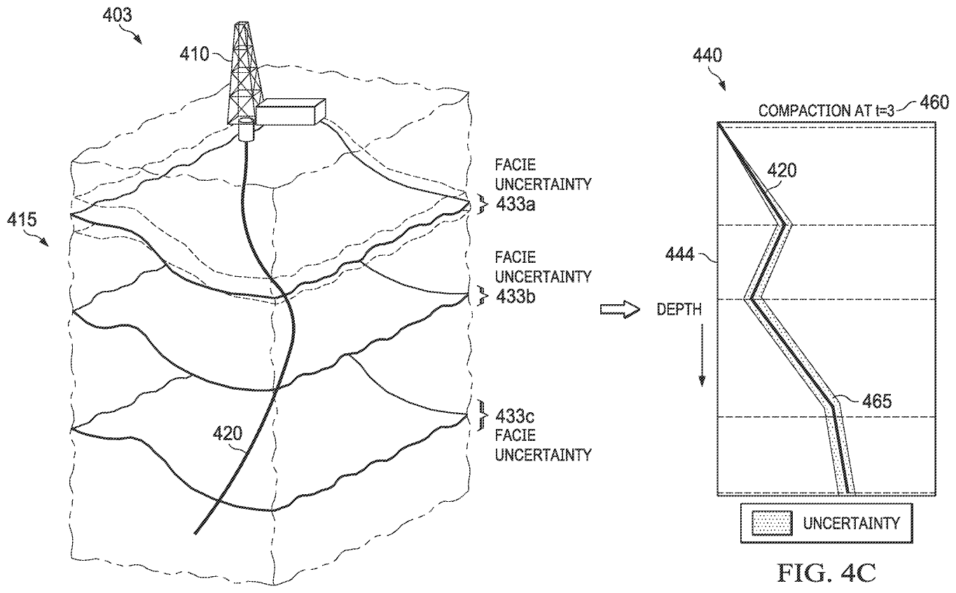

FIG. 4A is an illustration of a diagram of an example uncertainty of characteristics of a subterranean formation at a first time interval;

FIG. 4B is an illustration of a diagram of an example uncertainty of characteristics of the subterranean formation at a second time interval;

FIG. 4C is an illustration of a diagram of an example uncertainty of characteristics of the subterranean formation at a third time interval;

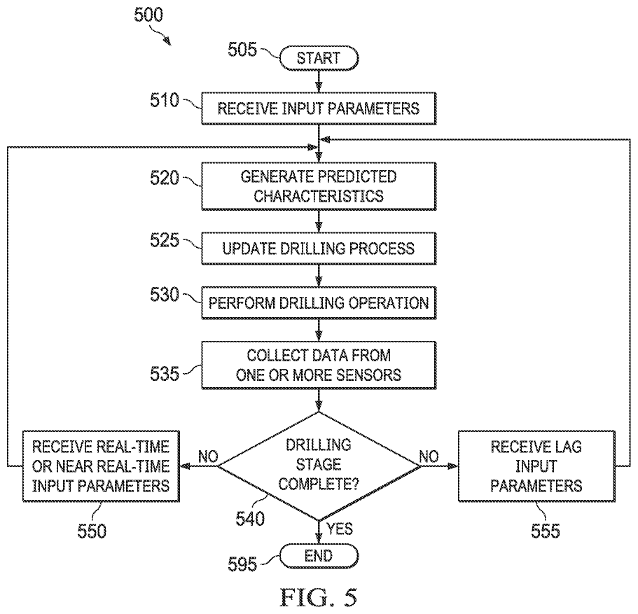

FIG. 5 is an illustration of a flow diagram of an example method for predicting characteristics of a subterranean formation;

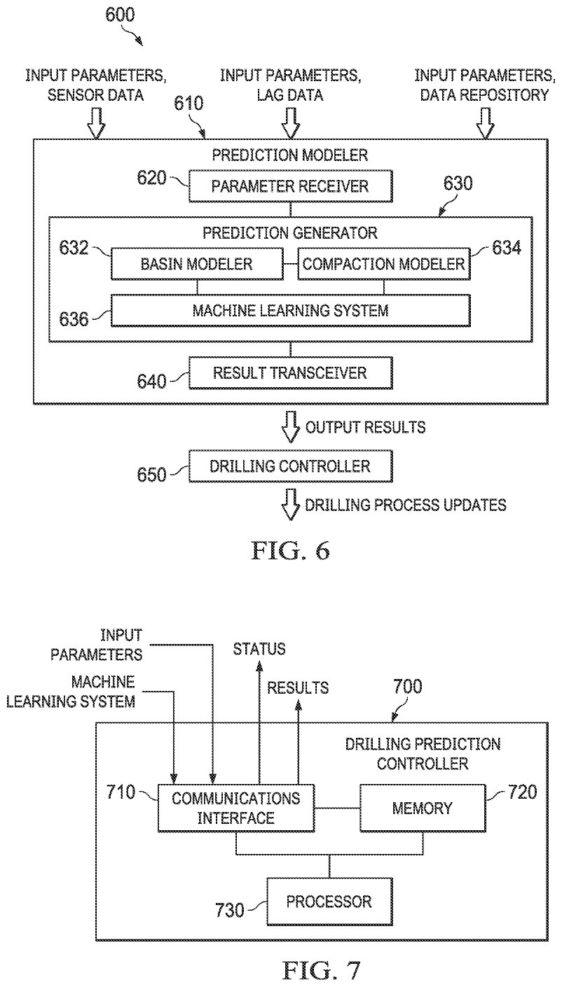

FIG. 6 is an illustration of a block diagram of an example prediction modeler system; and

FIG. 7 is an illustration of a block diagram of an example of a drilling prediction controller according to the principles of the disclosure.

### DETAILED DESCRIPTION

When drilling a borehole system, various factors are utilized to attempt to optimize the drilling process. For example, factors can include the drill bit pressure, the drill bit rotational speed, the type of drilling fluid or mud utilized, the composition of the drilling fluid or mud, the types of additives utilized in the drilling fluid or mud, and other drilling factors. Other factors that can be used as inputs are the various characteristics of the subterranean formation, e.g., rock properties, in which the drilling process is drilling through, for example, the compaction of the subterranean formation, the porosity of the subterranean formation, and the composition of the subterranean formation. The borehole system can be for hydrocarbon production purposes, scientific or research purposes, or other purposes.

The characteristics of the subterranean formation are typically estimated within an uncertainty range until downhole tools can be positioned to perform more precise measurements, such as using various sensors, for example, a reservoir description tool. Improving the estimation of the characteristics of the subterranean formation that lies ahead of the drilling system, e.g., the look ahead area, can enable an improved optimization of the drilling factors and fluid factors utilized which can reduce costs, such as allowing the drilling to proceed at a faster pace or minimizing the wear and tear of downhole tools, such as with the drill bit assembly.

This disclosure presents methods and processes to reduce the estimation uncertainty of the characteristics of the subterranean formation around and ahead of the drill bit assembly thereby improving the drilling operation optimizations, such as the rate of penetration (ROP). The disclosed methods and processes can be used to maintain the equivalent circulation density (ECD) near the calculated fracture gradient enabling the unrealized ROP opportunity to be identified and used toward optimizing the drilling process, while decreasing risk. Reducing the estimation uncertainty can be implemented by combining an analysis of the one or more basin models with geo-mechanical models to predict the characteristics of the subterranean formation. In some aspects, the cross validation of pore pressure prediction utilizing more than one method, e.g., basin modeling and geo-mechanical modeling, can reduce the estimation uncertainty of the characteristics of the subterranean formation.

In some aspects, the basin modeling analysis can utilize a finite volume algorithm to calculate fluid and rock properties for the initial modeling analysis. The disclosed processes can reduce the time taken to calculate these results, such as reducing the calculation time from 8 hours to 20 minutes or near-real time.

In some aspects, cuttings can be analyzed for various characteristics, such as cuttings porosity, cuttings hardness, and cuttings clay activity, where these characteristics can be used as inputs into the pore pressure prediction and compaction prediction, e.g., inputs to derive Young's modulus and Poisson's ratio. Clays found in the formation can tend to be more calcium containing rather than sodium containing as the depth increases. This information can be used to calibrate the basin model as the drilling process progress. In some aspects, the basin model can utilize data gathered from various sensors while drilling is progressing, such as a resistivity parameter, a gamma ray parameter, a subterranean formation temperature parameter, an electromagnetic parameter, and other parameters. In some aspects, the basin model can utilize drilling data such as the volume of gas, rotational speed of the drill bit assembly or drill string, weight on bit (WOB), and other drilling parameters.

In some aspects, these estimations can be made in real-time or near real-time enabling updates to be made to the drilling process while drilling is in progress. In some aspects, the analysis to generate the estimation uncertainty can be automated. In some aspects, adjustments to the drilling process can be automated.

Utilizing various sensors located downhole, information on the characteristics of the subterranean formation and characteristics of the active borehole fluids can be collected. These characteristics can include, but is not limited to, rock clay reactivity, rock lithology, specific surface area, hydrocarbon type (e.g., composition), formation tops, or compaction models. The collected characteristics can be used as inputs to the methods and processes to generate outputs, i.e., results, such as a pore pressure prediction, a fracture gradient, a compaction model, or one or more elastic moduli, such as Young's modulus or Poisson's ratio.

Turning now to the figures, FIG. 1 is an illustration of a diagram of an example drilling system 100, for example, a logging while drilling (LWD) system, a measuring while drilling (MWD) system, a seismic while drilling (SWD) system, a telemetry while drilling (TWD) system, injection well system, extraction well system, and other borehole systems. Drilling system 100 includes a derrick 105, a well site controller 107, and a computing system 108. Well site controller 107 includes a processor and a memory and is configured to direct operation of drilling system 100. Derrick 105 is located at a surface 106.

Extending below derrick 105 is an active borehole 110 with downhole tools 120 at the end of a drill string 115. Downhole tools 120 can include various downhole tools, such as a formation tester or a bottom hole assembly (BHA). At the bottom of downhole tools 120 is a drilling bit 122. Other components of downhole tools 120 can be present, such as a local power supply (e.g., generators, batteries, or capacitors), telemetry systems, sensors, transceivers, and control systems. Active borehole 110 is surrounded by subterranean formation 150.

Well site controller 107 or computing system 108 which can be communicatively coupled to well site controller 107, can be utilized to communicate with downhole tools 120, such as sending and receiving telemetry, data, instructions, subterranean formation measurements, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, measurements, and other information by various conventional means, now known or later developed, with computing system 108 or well site controller 107. Well site controller 107 or computing system 108 can communicate with downhole tools 120 using conventional means, now known or later developed, to direct operations of downhole tools 120.

The methods and processes disclosed herein can be implemented in the downhole tools 120, the well site controller 107, the computing system 108, or a combination thereof. In some aspects, downhole tools 120 can include one or more sensors to collect parameters of the subterranean formation and parameters of the borehole environment, such as fluid pressure, fluid temperature, and other parameters. In some aspects, part of the process can be implemented in downhole tools 120 and part can be implemented in well site controller 107, where downhole tools 120 is communicatively coupled to well site controller 107. For example, the geo-mechanical parameters and the rig state parameters can be received from a data store by the well site controller 107.

The well site controller 107 can also receive the collected basin model parameters from downhole tools 120. Well site controller 107 can utilize a combination of the geo-mechanical properties, the rig state parameters, and the basin model parameters to estimate the basin and compaction models for the borehole, thereby reducing the estimation uncertainty. The generated results can be communicated to derrick 105 and other equipment to adjust the drilling process to improve the drilling efficiency. In some aspects, the algorithms or part of the algorithms can be implemented in computing system 108.

FIG. 2 is an illustration of a diagram of an example offshore system 200 with an electric submersible pump (ESP) assembly 220. ESP assembly 220 is placed downhole in an active borehole 210 below a body of water 240, such as an ocean or sea. Active borehole 210, protected by casing, screens, or other structures, is surrounded by subterranean formation 245. ESP assembly 220 can be used for onshore operations. ESP assembly 220 includes a well controller 207 (for example, to act as a speed and communications controller of ESP assembly 220), an ESP motor 214, and an ESP pump 224.

Well controller 207 is placed in a cabinet 206 inside a control room 204 on an offshore platform 205, such as an oil rig, above water surface 244. Well controller 207 is configured to adjust the operations of ESP motor 214 to improve well productivity. In the illustrated aspect, ESP motor 214 is a two-pole, three-phase squirrel cage induction motor that operates to turn ESP pump 224. ESP motor 214 is located near the bottom of ESP assembly 220, just above downhole sensors within active borehole 210. A power/communication cable 230 extends from well controller 207 to ESP motor 214. A fluid pipe 232 fluidly couples equipment located on offshore platform 205 and ESP pump 224.

In some aspects, ESP pump 224 can be a horizontal surface pump, a progressive cavity pump, a subsurface compressor system, or an electric submersible progressive cavity pump. A motor seal section and intake section may extend between ESP motor 214 and ESP pump 224. A riser 215 separates ESP assembly 220 from water 240 until sub-surface 242 is encountered, and a casing 216 can separate active borehole 210 from subterranean formation 245 at and below sub-surface 242. Perforations in casing 216 can allow the fluid of interest from subterranean formation 245 to enter active borehole 210.

In some aspects, well controller 207 can perform the operations as described herein. Well controller 207 can receive downhole data from downhole tools that are part of ESP pump 224. In some aspects, ESP pump 224 can perform the operations. In some aspects, a combination of well controller 207 and ESP pump 224 can perform the operations.

FIG. 1 depicts an onshore operations. Those skilled in the art will understand that the disclosure is equally well suited for use in offshore operations, such as shown in FIG. 2. FIGS. 1 and 2 depict specific active borehole configurations, those skilled in the art will understand that the disclosure is equally well suited for use in boreholes having other orientations including vertical boreholes, horizontal boreholes, slanted boreholes, multilateral boreholes, and other borehole types.

FIG. 3 is an illustration of a block diagram of an example drilling prediction flow 300. Drilling prediction flow 300 can be implemented in one or more controllers or computing systems, such as prediction modeler system 600 of FIG. 6 or drilling prediction controller of FIG. 7. In some aspects, drilling prediction flow 300 can be implemented using a combination of computing systems located proximate the drilling location and distant from the drilling location, as well as using a computing system located downhole.

Drilling prediction flow 300 begins with a geo-mechanical model and an initial basin model being generated in a prediction model 310, such as using data received from a data store, for example a data repository 320. Data repository 320 can located proximate the drilling site, such as with a well site controller, or be located distant from the drilling site, for example, a data center, a cloud environment, a server, a mobile device, a smartphone, or other computing system. Data repository 320 can include characteristics of the subterranean formation previously collected, such as from a nearby borehole, from surface sensors, from geologic and lithology models, stratigraphic parameters, and other data parameters. Prediction model 310 can also receive data from a near real-time or real-time operations 330, for example, sensors located in or near the active borehole being drilled.

Prediction model 310 can output the generated results, such as the pore pressure prediction, the compaction model, the basin model, the fracture gradient prediction, one or more elastic moduli, and other result parameters. These parameters can be used as inputs to the drilling controller, such as a rig controller 340. Rig controller 340, which can be a borehole controller, drilling controller, or a well site controller, can adjust the drilling rotational speed, the torque applied, the ROP, the drilling fluid volume, pressure, temperature, or composition, as well as adding or removing additives to the drilling fluid or mud to improve the drilling process and efficiency.

As drilling proceeds, additional information can be collected from various sensors, such as a reservoir description tool and other types of sensors. The information can be related to the characteristics of the subterranean formation, the drilling fluid, the borehole environment, or the drill bit assembly. This information can be collected in real-time or near real-time as shown by box 350. The drilling fluid or mud can be analyzed along with logging information such as shown by box 352. The fluid composition can be analyzed as shown by box 354. Cuttings can be analyzed, such as the hardness, the mineral composition, or the porosity as shown by box 356. Cuttings information can have a lag in when the information can be utilized by the other aspects of the processes, for example, when cuttings are transported to the surface and analyzed at a surface location. A leak off test (LOT) 358 for determining pore pressure can be conducted downhole. The characteristics of the drill bit assembly can include the ROP, the vibration, and collected log parameters, as shown by box 360.

The information, e.g., characteristics or parameters, as identified by box 350 can be utilized, in combination with other received parameters, for example, from data repository 320, to generate real-time or near real-time leanings, as shown by box 370. One or more of the learnings from box 370 can be updated. These learnings include updating the lithology parameters 372 of the subterranean formation, updating the lithology and fluid parameters 374 of the subterranean formation, updating the lithology and compaction parameters 376, or updating the tectonic history 378 of the subterranean formation.

The information from box 350 and the updates to the learnings from box 370 can be utilized by operations 330 to generate updated result parameters that can be utilized to update prediction model 310, which in turn updates rig controller 340. As information becomes available, such as real-time or near real-time from some sensors or with a lag time data, such as when analyzing cuttings, prediction model 310 can provide updated result parameters to prediction model 310. The result parameters can include, but are not limited to, the predicted pore pressure, the basin model, the compaction model, the fracture gradient, one or more elastic moduli, and other result parameters. The result parameters, from each iteration of operations 330 at a different time interval, can reduce the uncertainty of the predictions generated by prediction model 310.

FIG. 4A is an illustration of a diagram of an example uncertainty 401 of characteristics of a subterranean formation at a first time interval. Uncertainty 401 demonstrates the potential reduction in uncertainty of the prediction models of the characteristics of the subterranean formation as information is received from downhole sensors and processed through the methods and processes disclosed herein. Uncertainty 401 has a drilling rig 410 at a surface location of the borehole and various subterranean formation layers 415 under the drilling rig 410. Extending below drilling rig 410 is an active borehole 420, shown as a dark line extending downward. Active borehole 420 is the drilled borehole at a measured depth of the borehole. A drill bit assembly can be at the downhole end of active borehole 420, not shown. Extending below active borehole 420 is a projected borehole path 425 which is the planned path of the borehole drilling operation, shown as a light line.

Facie uncertainty bracket 431a, facie uncertainty bracket 431b, and facie uncertainty bracket 431c, collectively facie uncertainty brackets 431, visually show an amount of uncertainty of the characteristics of the subterranean formation as generated by the prediction model. The size of facie uncertainty brackets 431 provide a visual cue as to the amount of uncertainty at each facie layer at the three selected measured depths.

The visualization of the uncertainty amount can also be displayed using a side view 440 of active borehole 420 and projected borehole path 425. Uncertainty 401 is generated at a first time interval 442 and shows an increasing measured depth 444 in the downward direction. Uncertainty area 448, shown as the gray area surrounding active borehole 420 and projected borehole path 425, is narrow at the higher depths and wider at the deeper depths where the width indicates a relative uncertainty of the predicted characteristics of the subterranean formation. The uncertainty of the predictions increases as the depth increases below the end of active borehole 420.

FIG. 4B is an illustration of a diagram of an example uncertainty 402 of characteristics of the subterranean formation at a second time interval 450. Uncertainty 402 is similar to that of uncertainty 401. Active borehole 420 is shown to be drilled to a deeper measured depth in uncertainty 402 as compared to uncertainty 401. Respectively, the projected borehole path 425 is shorter. Facie uncertainty bracket 432a is shown to be a smaller size as compared to facie uncertainty bracket 431a. The same is shown respectively for facie uncertainty bracket 432b and facie uncertainty bracket 432c.

Side view 440 has been updated from FIG. 4A, to show an updated uncertainty area 455. Uncertainty area 455 is smaller in width than uncertainty area 448 which indicates that the characteristics of the subterranean formation have less uncertainty from the prediction model as the new information and sensor data collected at second time interval 450 is used according to the methods and processes described herein.

FIG. 4C is an illustration of a diagram of an example uncertainty 403 of characteristics of the subterranean formation at a third time interval 460. Uncertainty 403 is similar to that of uncertainty 401 and uncertainty 402. Active borehole 420 is shown to be drilled to a deeper measured depth in uncertainty 403 as compared to uncertainty 401 and uncertainty 402. Facie uncertainty bracket 433a is shown to be a smaller size as compared to facie uncertainty bracket 432a. The same is shown respectively for facie uncertainty bracket 433b and facie uncertainty bracket 433c.

Side view 440 has been updated from FIG. 4B, to show an updated uncertainty area 465. Uncertainty area 465 is smaller in width than uncertainty area 455 which indicates that the characteristics of the subterranean formation have less uncertainty from the prediction model as the new information and sensor data collected at third time interval 460 is used according to the methods and processes described herein.

FIG. 5 is an illustration of a flow diagram of example method 500 for predicting characteristics of a subterranean formation. Method 500 can be performed on a computing system, such as a well site controller, a server, a laptop, a mobile device, a cloud computing system, or other computing system capable of receiving the input parameters and outputting results. Other computing systems can be a smartphone, a mobile phone, a PDA, a laptop computer, a desktop computer, a server, a data center, a cloud environment, or other computing system. The prediction modeler system 600 of FIG. 6 and the drilling prediction controller 700 of FIG. 7 provide examples of computing systems in which at least a portion of the method 500 can be performed.

The computing system can be located proximate a borehole or can be located in a data center, a cloud environment, a lab, a corporate office, or other distance locations. Method 500 can represent an algorithm and be encapsulated in software code or in hardware, for example, an application, a code library, a dynamic link library, a module, a function, a RAM, a ROM, and other software and hardware implementations. The software can be stored in a file, database, or other computing system storage mechanism. Method 500 can be partially implemented in software and partially in hardware. For example, processor 730 of FIG. 7 is capable of performing some or all of the steps of method 500.

The largest uncertainty of the characteristics of the subterranean formation would occur prior to a start of a drilling stage since that is a point where the least amount of downhole information is known as compared to the remaining time intervals of the drilling stage. As the real-time or near real-time data is received, the lithology marker or tops can be updated and the uncertainty of the characteristics of the subterranean formation can be reduced. As the lag time data, such as cuttings analysis, is received, the uncertainty can be further reduced. The process can loop to modify the prediction model until the end of the drilling stage. Use of the lag time data can improve the prediction model in the look ahead area, ahead of the drilling bit, since the basin model and compaction model predictions of the characteristics of the subterranean formation can utilize a larger analysis of the geological structure.

One or more types of data can be used in the methods and processes. For example, for mud logging there can be two different elements with different time scales, such as logs and cuttings. In real-time or near real-time drilling, gamma ray parameter, resistivity parameter, or sonic parameter logs can be collected and communicated to the prediction model. In some aspects, a machine learning system can be utilized to update a lithology proxy model and to output a revised lithology for the basin model to be used by the prediction modeling process. The prediction model can be run in an iterative fashion as new sensor data is received thereby generating updated characteristics of the subterranean formation, which can be used by the drilling process.

The iterative updating of the prediction model can enable advantages, such as lithology and mineral composition can be received with a lag and can reduce uncertainty of the compaction model, can lead to more insights regarding the lithology, can lead to an increase understanding of the rock fabric, reduce the uncertainty of the subterranean permeability and porosity, can allow the collection of parameters from formation pressure tests to be used by the prediction model, and can enable a common platform to process the basin model, the real-time or near real-time data, the lag time data, the rock properties and the borehole properties. Interdependencies between the rock properties and the compaction model can enable the use of machine learning techniques which can use classifications such as lithology or lithology proxy, hydrocarbon type, or other classifications.

Method 500 starts at a step 505 and proceeds to a step 510 where input parameters are received. In some aspects the input parameters include one or more of geo-mechanical parameters, basin parameters, lithology parameters, or borehole parameters from proximate boreholes. The input parameters can be received from sensors, such as surface sensors or downhole sensors, or from a data repository. In some aspects the input parameters can include the anticipated downhole conditions, for example, mineralogy parameters, subterranean formation temperature parameters, pressure parameters, fluid parameters, electromagnetic parameters, and other downhole conditions. In some aspects, default parameters can be utilized in place of receiving one or more of the input parameters. In some aspects, a machine learning algorithm can be used in place of some of the input parameters, for example, the downhole condition factors can be determined using an output from the machine learning algorithm to improve the efficiency of the method results.

Proceeding to a step 520, a prediction model is utilized to generate one or more predictions, e.g., estimates, of characteristics of the subterranean formation utilizing the input parameters. The predictions can include a compaction model, a basin model, a pore pressure prediction, one or more elastic moduli, a fracture gradient, and other characteristics. The results of the prediction model can be across a range of depths of the borehole and the projected borehole path, so that the area surrounding the drill bit assembly, including the look ahead area, can be covered by the results. As the distance increases along the projected drilling path of the borehole, the uncertainty of the results from the prediction model also increases. As new input parameters are received during the drilling process, the uncertainty of the results can be reduced to increase the accuracy of the results thereby improving the efficiency and optimization of the drilling process.

Proceeding to a step 525, the results of the prediction model can be used as inputs into a drilling process. In some aspects, the results can be used by a drilling controller to adjust mechanical drilling parameters, for example, rotational speed of the drill string, the ROP, the WOB, and other mechanical drilling parameters. In some aspects, the results can be used by a drilling controller to adjust the drilling fluid or mud composition or additives within the drilling fluid or mud. In some aspects, the results can be reviewed by a user prior to adjusting the drilling process. For example, the user can define a range or an amount of change from the previous results where if the change in results is less than a determined amount, the drilling process can be updated without user intervention and a change in results equal to or greater than a determined amount would require a user interaction to update the drilling process. The change in results can be measured from one or more of the results, for example, if the pore pressure prediction or the elastic moduli parameter varies by more than the determined amount. In some aspects, the determined amount can be a 5% change in the results.

Proceeding to a step 530, the drilling controller, which can be a well site controller or another type of controller, can direct operations of the drilling process, such as directing the drill bit assembly downhole and directing the pumping and composition of drilling fluids or muds. The drilling process can continue for a determined drilling time interval. The drilling time interval can be one or more time intervals, for example, the time interval can be shorter in respect to receiving updates via real-time or near real-time sensor data, and longer in respect to receiving updates via lag time data.

Proceeding to a step 535, update sensor data can be collected from downhole and surface sensors. The data collected from downhole sensors can represent a different portion of the borehole then the surface data, such as when the surface data is an analysis of cuttings pumped to the surface. In a decision step 540, a determination is made whether the drilling stage is completed. If ‘Yes’, then method 500 proceeds to a step 595 and ends. If ‘No’, method 500 proceeds to one or more of a step 550 or a step 555.

In step 550, the prediction process can receive the collected sensor data from step 535 and process the real-time or near real-time data. In step 555, the prediction process can receive the collected sensor data from step 535 and process the lag time data. In some aspects, step 550 or step 555 can adjust the collected data according to the depth to which the collected data corresponds. Proceeding from step 550 or proceeding from step 555, method 500 proceeds to step 520 where the collected data can be used to update the input parameters used by the prediction model. The prediction model of step 520 can regenerate new results. Step 550 and step 555 can proceed independently of each other, for example, step 550 can be performed multiple times as near real-time data is received as compared to step 555 as lag time data is received from other sensors.

FIG. 6 is an illustration of a block diagram of an example prediction modeler system 600, which can be implemented using one or more computing systems, for example, a well site controller, a drilling controller, a reservoir controller, a data center, a cloud environment, a server, a laptop, a smartphone, a mobile phone, a tablet, and other computing systems. The computing system can be located proximate the well site, or a distance from the well site, such as in a data center, cloud environment, corporate location, a lab environment, or another location. The computing system can be a distributed system having a portion located proximate the borehole and a portion located remotely from the well site, for example, having a data repository at distant location from the borehole, such as a cloud environment, and the prediction modeler located proximate the borehole.

Prediction modeler system 600, or a portion thereof, can be implemented as an application, a code library, a dynamic link library, a function, a module, other software implementation, or combinations thereof. In some aspects, prediction modeler system 600 can be implemented in hardware, such as a ROM, a graphics processing unit, or other hardware implementation. In some aspects, prediction modeler system 600 can be implemented partially as a software application and partially as a hardware implementation. In some aspects, prediction modeler system 600 can be implemented using drilling prediction controller 700 of FIG. 7.

Prediction modeler system 600 has a prediction modeler 610 that includes a parameter receiver 620, a prediction generator 630, a basin modeler 632, a compaction modeler 634, and a result transceiver 640. In some aspects, a machine learning system 636 can be present. The results and outputs from prediction modeler 610 can be communicated to another system, such as one or more of a well site controller, a drilling controller 650, a computing system, or a user. In some aspects, the communicated results can be used as inputs to by a system or a user to adjust a drilling process of the borehole. A memory or data storage of prediction modeler 610 can be configured to store the processes and algorithms for directing the operations thereof.

Parameter receiver 620 can receive input parameters to direct further operations. The input parameters can be parameters, instructions, directions, data, and other information to enable or direct the remaining processing of prediction modeler system 600. In some aspects, the input parameters include geo-mechanical parameters of the subterranean formation at one or more depths, a lithology of the subterranean formation at one or more depths, and a basin model of the subterranean formation at one or more depths. In some aspects, the input parameters can include the anticipated downhole conditions, for example, mineralogy parameters, temperature parameters, pressure parameters, fluid parameters, electromagnetic parameters, and other downhole parameters. In some aspects, the input parameters can include sensor data collected from downhole sensors or surface sensors. In some aspects, the input parameters can include data retrieved from a data repository, for example, previously collected downhole data from the current or proximate boreholes. In some aspects, the input parameters can be real-time or near real-time parameters from the sensor data. In some aspects, the input parameters can be lag time parameters from the sensor data.

In some aspects, default parameters can be specified by prediction modeler 610, where those parameters can be utilized in place of receiving one or more of the input parameters. In some aspects, prediction modeler 610 can utilize a machine learning algorithm, such as from machine learning system 636, to generate one or more of the input parameters, for example, the downhole condition factors can be determined using an output from the machine learning algorithm to improve the efficiency of the method results.

Prediction generator 630 is capable to implement the processes and methods as described herein utilizing the input parameters. Prediction generator 630 is capable to use one or more algorithms to determine the results, such as the basin model, the compaction model, the elastic moduli, and the fracture gradients. Prediction generator 630 is capable to direct operation of basin modeler 632, compaction modeler 634, and machine learning system 636. Basin modeler 632 is capable to perform operations to determine basin model parameters from predictions made utilizing the input parameters. Compaction modeler 634 is capable to perform operations to calculate compaction models and generate results, such as fracture gradients, utilizing the input parameters. Machine learning system 636 can be utilized by prediction generator 630, basin modeler 632, or compaction modeler 634 to determine updated input parameters or to produce the results using machine learning algorithms, where the predictions, e.g., estimations, are derived from the machine learning algorithms.

Prediction modeler system 600 demonstrates a functional view of the disclosure, and the described functions can be implemented in one or more functional units, for example, parameter receiver 620 or result transceiver 640 can be incorporated into prediction generator 630. In some aspects, basin modeler 632 and compaction modeler 634 can be implemented in the same modeler. In some aspects, basin modeler 632 or compaction modeler 634 can be incorporated into prediction generator 630.

Result transceiver 640 is capable to communicate one or more generated outputs and results (e.g., result parameters), such as predictions for characteristics of the subterranean formation at one or more depths, to one or more other systems, such as a well site controller, drilling controller 650, a computing system, a user, or other borehole related systems. The receiving system or user can utilize the results to adjust drilling process parameters. Parameter receiver 620 and result transceiver 640 can be, or can include, conventional interfaces configured for transmitting and receiving data.

FIG. 7 is an illustration of a block diagram of an example of a drilling prediction controller 700 according to the principles of the disclosure. Drilling prediction controller 700 can be stored on a single computer or on multiple computers. The various components of drilling prediction controller 700 can communicate via wireless or wired conventional connections. A portion of drilling prediction controller 700 can be located downhole at one or more locations and other portions of drilling prediction controller 700 can be located on a computing device or devices located at the surface or a distant location. In some aspects, drilling prediction controller 700 can be part of a wellsite job planner system for directing the drilling stages, and can be integrated in a single device.

Drilling prediction controller 700 can be configured to perform the various functions disclosed herein including receiving input parameters and generating results from an execution of a prediction modeler. Drilling prediction controller 700 includes a communications interface 710, a memory 720, and a processor 730.

Communications interface 710 is configured to transmit and receive data. For example, communications interface 710 can receive input parameters regarding the basin parameters, the geo-mechanical parameters, the drilling operation parameters, and the anticipated conditions that will be experienced downhole a borehole. Communications interface 710 can transmit the results (e.g., the pore pressure and the fracture gradient) and intermediately generated data (e.g., the basin model and the compaction model using the updated input parameters).

In some aspects, communications interface 710 can transmit a status, such as a success or failure indicator of drilling prediction controller 700 regarding receiving the input parameters, transmitting the results, or generating the results. In some aspects, communications interface 710 can receive input parameters from a machine learning system, such as borehole conditions that could be experienced downhole during the time interval of the drilling process. Communications interface 710 can communicate via communication systems used in the industry. For example, wireless or wired protocols can be used. Communication interface 710 is capable of performing the operations as described for parameter receiver 620 and result transceiver 640.

Memory 720 can be configured to store a series of operating instructions that direct the operation of processor 730 when initiated, including the code representing the algorithms for determining the predictions for the basin model, the compaction model, and other result parameters. Memory 720 is a non-transitory computer readable medium. Multiple types of memory can be used for data storage and memory 720 can be distributed.

Processor 730 can be configured to determine results and statuses utilizing the received input parameters, and, if provided, the machine learning system inputs. For example, the processor 730 can generate predicted results for the basin model and compaction model by applying the updated input parameters and the anticipated downhole conditions, such as method 500 of FIG. 5. Processor 730 can be configured to direct the operation of the drilling prediction controller 700. Processor 730 includes the logic to communicate with communications interface 710 and memory 720, and perform the functions described herein to determine the results and statuses. Processor 730 is capable of performing or directing the operations as described by prediction generator 630, basin modeler 632, compaction modeler 634, and machine learning system 636.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, because the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving input parameters for a prediction model of an active borehole for a drilling stage, wherein the prediction model utilizes a basin model and a compaction model;
generating predicted characteristics of a subterranean formation of the active borehole utilizing the prediction model and the input parameters; and
reducing an estimation uncertainty of the predicted characteristics of the subterranean formation by analyzing a geo-mechanical model with the basin model, and updating the basin model using sensor data collected from sensors located downhole or proximate the active borehole, and the sensor data is collected in a real-time, a near real-time, or at a lag time.

2. The method as recited in claim 1, further comprising:
updating a drilling process utilizing the predicted characteristics of the subterranean formation; and
communicating the drilling process to a drill bit assembly, a rig, a drilling controller, or a well site controller, wherein the predicted characteristics include a prediction of characteristics of the subterranean formation in a look ahead area of the drill bit assembly.

3. The method as recited in claim 2, wherein the updating is performed by the drilling controller or the well site controller.

4. The method as recited in claim 2, wherein the updating the drilling process includes an adjusting of one or more of a rotational speed of the drill bit assembly, a rate of penetration, a weight on bit, a steering of the drill bit assembly, a drilling fluid composition, a drilling fluid additive, a drilling fluid volume, or a drilling fluid flow rate.

5. The method as recited in claim 1, further comprising:
modifying the input parameters utilizing the real-time or near real-time data at a first time interval;
modifying the input parameters utilizing lag time data at a second time interval; and
repeating the generating of the predicted characteristics of the subterranean formation and the reducing the estimation uncertainty at the first time interval and the second time interval until the drilling stage is completed.

6. The method as recited in claim 1, further comprising:
maintaining an equivalent circulation density near a calculated fracture gradient utilizing the predicted characteristics.

7. The method as recited in claim 1, wherein an initial model of the basin model is determined utilizing a finite volume algorithm to calculate one or more fluid or rock properties.

8. The method as recited in claim 1, wherein the input parameters include one or more of a geo-mechanical parameters, the basin model, and the compaction model.

9. The method as recited in claim 1, wherein the input parameters include data received from a data repository.

10. The method as recited in claim 1, wherein the sensor data includes one or more of a rock clay reactivity, a rock lithology, a specific surface area, a hydrocarbon type, a formation top, parameters for the compaction model, a cuttings hardness, a cuttings porosity, a resistivity parameter, a subterranean formation temperature parameter, a gamma ray parameter, or a vibration parameter.

11. The method as recited in claim 1, wherein the predicted characteristics of the subterranean formation include one or more of an updated basin model, a pore pressure prediction, a fracture gradient, an updated compaction model, or one or more elastic moduli.

12. A prediction modeler system, comprising:
a parameter receiver, capable to receive input parameters relating to an active borehole and a subterranean formation in which the active borehole is located; and
a prediction generator, capable of utilizing the input parameters to determine result parameters including one or more basin models, one or more compaction models, one or more fracture gradients, or one or more elastic moduli, wherein the input parameters are modified during a drilling stage using first sensor data collected in real-time, near real-time, and at a lag time.

13. The prediction modeler system as recited in claim 12, further comprises:
a data repository, capable of providing one or more input parameters to the parameter receiver, wherein the data repository includes second sensor data collected from one or more proximate boreholes of the active borehole, third sensor data collected from previous drilling stages of the active borehole, lithology of the subterranean formation, geo-mechanical parameters, and stratigraphic parameters.

14. The prediction modeler system as recited in claim 12, further comprises:
a result transceiver, capable of communicating the result parameters; and
a drilling controller, capable of receiving the result parameters and directing operations of a drilling system.

15. The prediction modeler system as recited in claim 14, wherein the operations are adjusting one or more of a drill bit assembly or a composition of a drilling fluid.

16. The prediction modeler system as recited in claim 12, wherein the first sensor data includes one or more of real-time or near real-time data of a porosity parameter of the subterranean formation, a temperature parameter within the active borehole, a resistivity parameter, a gamma ray parameter, an electromagnetic parameter, or lag time parameters of a cuttings hardness, a cuttings porosity, or a cuttings clay reactivity.

17. The prediction modeler system as recited in claim 12, wherein the input parameters are one or more of the one or more basin models, the one or more compaction models, a geo-mechanical parameter, a lithology parameter, or a stratigraphic parameter.

18. A computer program product having a series of operating instructions stored on a non-transitory computer-readable medium that directs a data processing apparatus when executed thereby to perform operations, the operations comprising:
receiving input parameters for a prediction model of an active borehole for a drilling stage, wherein the prediction model utilizes a basin model and a compaction model;
generating predicted characteristics of a subterranean formation of the active borehole utilizing the prediction model and the input parameters; and
reducing an estimation uncertainty of the predicted characteristics of the subterranean formation by analyzing a geo-mechanical model with the basin model, and updating the basin model using sensor data collected from sensors located downhole or proximate the active borehole, and the sensor data is collected in a real-time, a near real-time, or at a lag time.

19. The computer program product as recited in claim 18, further comprising:
updating a drilling process utilizing the predicted characteristics of the subterranean formation; and
communicating the drilling process to a drill bit assembly, a rig, a drilling controller, or a well site controller, wherein the predicted characteristics include a prediction of characteristics of the subterranean formation in a look ahead area of the drill bit assembly.

20. The computer program product as recited in claim 18, further comprising:
modifying the input parameters utilizing the real-time or near real-time data at a first time interval;
modifying the input parameters utilizing lag time data at a seconds time interval; and
repeating the generating of the predicted characteristics of the subterranean formation and the reducing the estimation uncertainty at the first time interval and the second time interval until the drilling stage is completed.

21. The computer program product as recited in claim 18, wherein the input parameters include one or more of a geo-mechanical parameter, the basin model, or the compaction model, and wherein one or more parameters of the input parameters are received from a data repository.
